(19) United States
(12) Patent Application Publication
(10) Pub. No.: US 2013/0263188 A1
(43) Pub. Date: Oct. 3, 2013

(54) ELECTRONIC DEVICE AND METHOD FOR DISPLAYING PRODUCT INFORMATION IN TV PROGRAMS

(71) Applicant: HON HAI PRECISION INDUSTRY CO., LTD., New Taipei (TW)

(72) Inventors: CHUNG-I LEE, New Taipei (TW); HO-I SUN, New Taipei (TW)

(73) Assignee: HON HAI PRECISION INDUSTRY CO., LTD., New Taipei (TW)

(21) Appl. No.: 13/901,612

(22) Filed: May 24, 2013

Related U.S. Application Data
(63) Continuation of application No. 13/097,071, filed on Apr. 29, 2011, now abandoned.

(30) Foreign Application Priority Data
Aug. 9, 2010 (TW) 099126403

(51) Int. Cl. H04N 21/478

(52) U.S. Cl. CPC H04N 21/478
USPC 725/60

(57) ABSTRACT

A method of displaying product information in TV programs with product placements is applied in an electronic device. The electronic device encloses products presented in the TV program in graphic boxes, associates the graphic boxes with information related to the products, and defines keywords related to the products. The graphic boxes and the associated information is first hidden in the TV program. When a selection operation of selecting a product in the TV program is detected, the electronic device displays the graphic box that encloses the selected product, and displays information associated with the selected product in the TV program. Furthermore, the electronic device loads one or more keywords of the selected product to a search engine, to search for more information related the selected product according to keywords, and displays the searched information on a display device for users to view.

### CROSS-REFERENCE TO RELATED APPLICATIONS

This application is a continuation-in-part application of U.S. Ser. No. 13/097,071, filed Apr. 29, 2011.

### BACKGROUND

1. Technical Field

Embodiments of the present disclosure generally relate to advertisement displaying devices and methods, particularly to an electronic device and method for displaying product information in TV programs with product placements.

2. Description of Related Art

Product placement is increasingly becoming a popular form of advertising in today's media environment, especially with the growing use of digital recording devices such as TIVO and DVR that allow viewers to skip commercials. While there are numerous advantages to this marketing strategy, one major disadvantage is that the viewers have no concrete information on what the product is or even where to purchase it. This lack of information contributes to the lack of sales growth often associated with effective advertising.

### BRIEF DESCRIPTION OF THE DRAWINGS

FIG. 1 is a block diagram of one embodiment of an electronic device including an information displaying unit.

FIG. 2 is a block diagram of one embodiment of function modules of the information displaying unit of FIG. 1.

FIG. 3 is a flowchart illustrating one embodiment of a method for displaying product information in TV programs with product placements.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

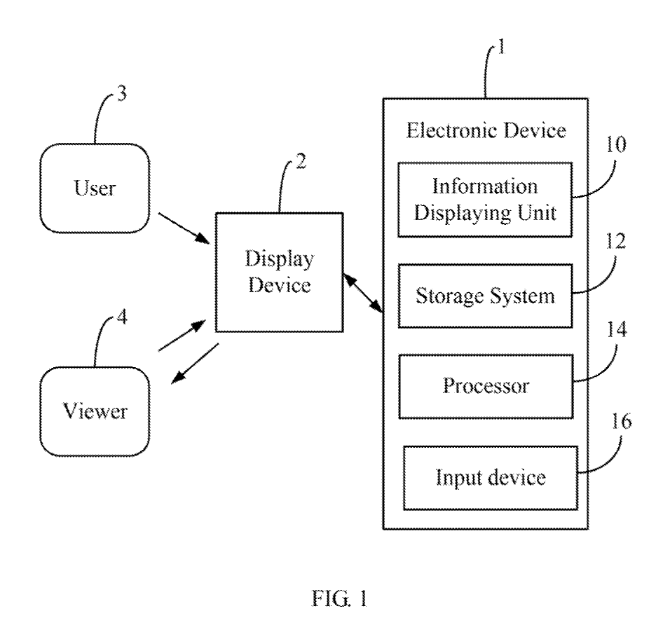

FIG. 1 is a block diagram of one embodiment of an electronic device 1 including an information displaying unit 10. In the embodiment, functions of the information displaying unit 10 are implemented by the electronic device 1. The information displaying unit 10 can search related information of products presented in a TV program from networks, and display the searched information on a display device 2 that is electronically connected to the electronic device 1 via a wired or wireless connection. In one embodiment, the products may be cars, watches, clothes, or any other goods appeared in the TV program. The searched information of the products may include web page and/or a website address. The TV program may be a movie, a TV series, or any other entertainment show.

In one embodiment, the electronic device 1 may be a computer, a TV, a portable electronic device, or any other electronic device that includes a storage system 12, at least one processor 14, and an input device 16 (such as a keyboard or a mouse). In another embodiment, the input device 16 is a remote control or a portable device, such as a cell phone or a tablet computer. In other embodiment, the input device 16 and the display device 2 are integrated as a touch-sensitive device.

The information displaying unit 10 is configured to receive keywords of products that may be presented on the TV program from a user 3 for a viewer 4 to use a search engine to search for related information of the products (e.g., an advertiser of the products). When the viewer 4 selects a product displayed in the TV program, the information displaying unit 10 can load one or more keyword of the selected product in the search engine to search related information of the selected product, and displays the searched information on the display device 2.

The display device 2 is used to receive a selection operation of the product from the viewer 4, and display the searched information of the selected product. In the embodiment, the display device 2 is a touch-sensitive display or a 3D display, and can receive an input operation of the viewer 4 using a finger, a stylus, or any other input device. For example, if the electronic device 1 is a TV, the viewer 4 can use a remote control to operate the electronic device 1.

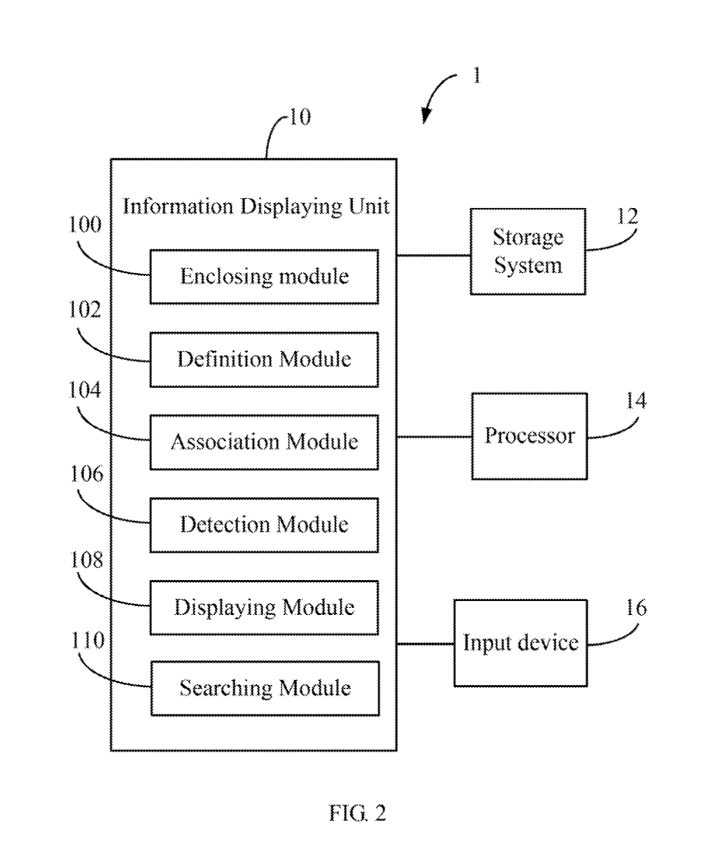

FIG. 2 is a block diagram of one embodiment of function modules of the information displaying unit 10 of FIG. 1. In one embodiment, the information displaying unit 10 includes an enclosing module 100, a definition module 102, an association module 104, a detection module 106, a displaying module 108, and a searching module 110. Each of the modules 100-110 may be a software program including one or more computerized instructions that are stored in the storage system 12 and executed by the processor 14.

In one embodiment, the storage system 12 may be a magnetic or an optical storage system, such as a hard disk drive, an optical drive, or a tape drive.

Before the display device 2 broadcasts a TV program, the enclosing module 100 encloses products presented in the TV program in graphic boxes. A graphic box can be a rectangle, a circle, lines, or a box drawn by the user 3. In the embodiment, the definition module 102 defines a size of the graphic box according to a displayed size of the product on the display device 2. The graphic box is firstly hidden in the TV program, and is activated to be displayed in the TV program in response to receiving a selection operation of selecting the product. In such a manner, the graphic box does not cause interfere of view of the TV program. For example, a viewer may be not interested in the products presented in the TV program, and do not perform any selection operation on the products embedded in the TV programs.

The definition module 102 further defines the keywords of the products that are enclosed by the graphic boxes. For example, the definition module 102 defines “007watch” as a keyword of a watch that is worn by a man in a TV series. The definition module 102 records the keywords in an image file that is compatible with the TV program. In one embodiment, the image file may be in a MPEG-2, MPEG-4, or an AVC format. In one embodiment, the image file is embedded in a TV signal or a video file of the TV program.

The association module 104 associates the graphic box of each product with information related to the product. In this embodiment, the information associated with the graphic box may include image information and character information. For example, a picture (or an enlarged picture) of the product, a brief description of the product (such as a brand/trade name) may be associated with the graphic box, which encloses the product in the TV program. The information associated with the graphic box is provided by the user 3 (e.g., the advertiser of the products) and stored in the storage system 12. In one embodiment, the information related to the graphic box is embedded in a TV signal or a video file of the TV program.

When the display device 2 displays the TV program, the detection module 106 detects a selection operation of selecting a product from the viewer 4. For example, if the display device 2 is a touch-sensitive display, the viewer 4 may use a finger or a stylus to select the product presented on the TV program, and then the detection module 106 detects the selection operation.

In response to detecting the selection operation of selecting the product, the displaying module 108 displays the graphic box that encloses the selected product in the TV program. The displaying module 108 further displays the information associated with the graphic box in the TV program, to show general information of the product to the viewer at the first time. The information associated with the graphic box may be displayed in the graphic box, or outside the graphic box. In such a manner, during the play of the TV program, the information associated with the products presented in the TV program is shown only on condition that the viewer prefers to understand the product. Otherwise, if the view does not show interest in the products, no information related to the products will be displayed during the play of the TV program. In other embodiment, when the selection operation is detected as being deactivated (e.g., removing from the object), the displaying module 108 does not display the graphic box and the information associated with the graphic box. For example, when a pointing device, such as a cursor, a finger, or a stylus removes from the selected product in the TV program, the displayed graphic box and the associated information disappear from the TV program. In addition, the viewer 4 does not know which products are enclosed by the graphic boxes, since the graphic boxes are hidden. Therefore, when the viewer 4 selects a product that is not enclosed in a graphic box, in response to the selection operation, the information displaying unit 10 can generate a response signal, such as a dialog box on the display device 2 and a vibration of the cursor displayed on the display device, to prompt the viewer 4 that the selected product is not enclosed in a graphic box. For example, the dialog box may display information such as “Sorry, no information is provided about the selected product.” In one embodiment, the information displaying unit 10 may further control the input device 16, which controls the pointing device, to generate a response signal, such as a vibration of the input device, to prompt the viewer 4 that the selected product is not enclosed in a graphic box.

The searching module 110 loads one or more keywords of the selected product in a search engine, and searches more information related to the selected product from networks using the search engine. In one embodiment, the search engine may be predetermined such as use of an Internet search engine or other searching tools, and the related information may be web pages, and/or website addresses. As mentioned above, the search engine may be predetermined. For one example, the searching module 110 is triggered when the product is selected by the viewer 4. For another embodiment, the searching module 110 is triggered, when the viewer 4 further selects the information associated with the graphic box after the viewer 4 further understands the selected product through the information associated with the graphic box.

The displaying module 108 further displays the searched information of the selected product on the display device 2, so the viewer 4 can browse the searched information from the display device 2. In other embodiment, the user 3 and the viewer 4 can operate the information displaying unit 10 by using different electronic devices 1 and different display devices 2.

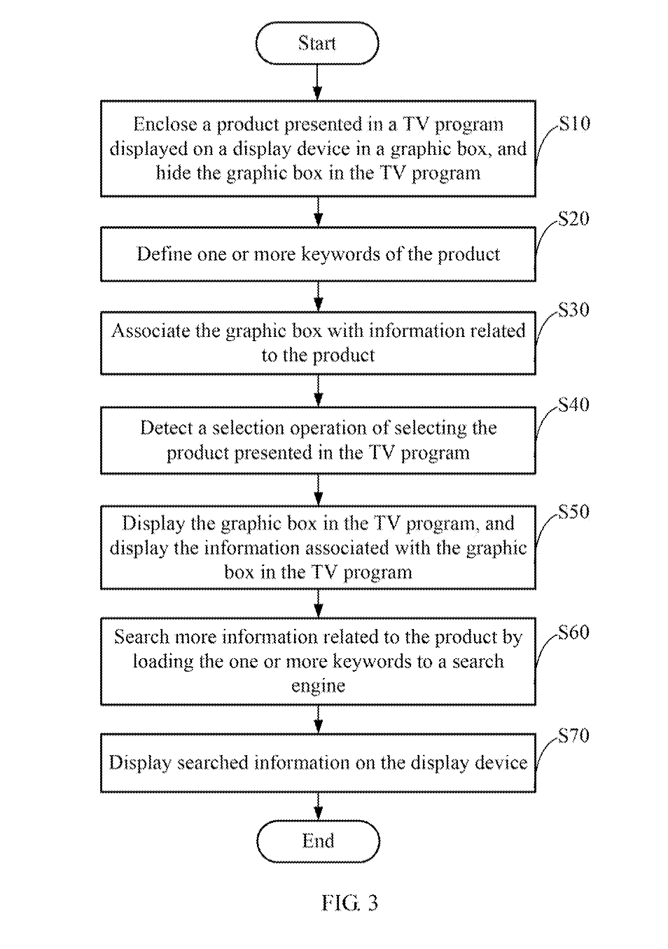

FIG. 3 is a flowchart illustrating one embodiment of a method for searching product information in TV programs with product placements. Depending on the embodiment, additional steps may be added, others removed, and the ordering of the steps may be changed. For example, in another embodiment, steps S20, S60 and S70 may be removed.

In step S10, the enclosing module 100 encloses a product presented in the TV program in a graphic box, and hides the graphic box in the TV program. In the embodiment, the TV program may be a movie, a TV series, or any other entertainment shown. The graphic box can be a rectangle, a circle, lines, or a box drawn by the user 3. In the embodiment, a size of the graphic box can be defined according to a displayed size of the product on the display device 2.

In step S20, the definition module 102 defines one or more keywords for each product. The definition module 102 records the one or more keywords of each product in an image file that is compatible with the TV program. The image file may be in a MPEG-2, MPEG-4, or an AVC format. In one embodiment, the image file is embedded in a TV signal or a video file of the TV program.

In step S30, the association module 104 associates the graphic box of each product with information related to the product. In this embodiment, the information associated with the graphic box may include image information and character information. For example, a picture (or an enlarged picture) of the product, a brief description of the product (such as a brand/trade name) may be associated with the graphic box, which encloses the product in the TV program. The association module 104 stores the information associated with the graphic box in the storage system 12. In one embodiment, the information related to the graphic box is embedded in a TV signal or a video file of the TV program.

In step S40, the detection module 106 detects a selection operation of selecting a product presented in the TV program. For example, the selection operation may be detected from a pointing device, such as a cursor controlled by an input device (e.g., a mouse, or a keyboard) operated by a viewer, a finger of the viewer, or a stylus.

In step S50, in response to detecting the selection operation on the product, the displaying module 108 displays the graphic box that encloses the selected product in the TV program, and displays the information associated with the graphic box in the TV program, to show general information of the product to the viewer at the first time. The information associated with the graphic box may be displayed in the graphic box, or out of the graphic box. In other embodiment, when the selection operation is detected as being deactivated (e.g., removing from the selected product), the displaying module 108 does not display the graphic box and the information associated with the graphic box. For example, when a pointing device, such as a cursor, a finger, or a stylus removes from the selected product in the TV program, the displayed graphic box and the associated information disappear from the TW program. In such a manner, during play of the TV program, the information related to the products presented in the TV program does not interfere with viewing of the TV program.

In step S60, the searching module 110 searches more information related to the selected product by loading one or more keywords of the selected product in a search engine. In one embodiment, the search engine may be predetermined such as use of an Internet search engine or other searching tools, and the searched information may be web pages, and/or website addresses.

In step S70, the displaying module 108 displays the searched information of the selected product on the display device 2, so the viewer 4 can browse the searched information from the display device 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for displaying product information in TV programs displayed on a display device, comprising:
enclosing a product presented in a TV program in a graphic box, and hiding the graphic box in the TV program;
associating the graphic box with information related to the product; and
displaying the graphic box that encloses the product in the TV program, and displaying the information associated with the graphic box in the TV program, in response to detecting a selection operation of selecting the product.

2. The method of claim 1, further comprising:
defining one or more keywords for the product;
searching more information related to the product by loading one or more keywords of the product in a search engine, in response to detecting the selection operation of selecting the product; and
displaying the searched information on the display device.

3. The method of claim 1, further comprising:
when the selection operation is detected as being deactivated, not displaying the graphic box and the information associated with the graphic box.

4. The method of claim 1, wherein the information associated with the graphic box is displayed in the graphic box or outside the graphic box.

5. The method of claim 1, wherein the information associated with the graphic box comprises image information and character information.

6. The method of claim 5, wherein the information associated with the graphic box comprises a picture of the product and a brief description of the product.

7. The method of claim 1, further comprising:
defining a size of the graphic box according to a displayed size of the product on the display device.

8. The method of claim 2, further comprising:
recording the one or more keywords of the product in an image file that is compatible with the TV program.

9. The method of claim 8, wherein the image file is embedded in a TV signal or a video file of the TV program.

10. An electronic device, comprising:
at least one processor;
a storage system that stores one or more programs comprising instructions executed by the at least one processor to perform operations of:
enclosing a product presented in a TV program in a graphic box, and hiding the graphic box in the TV program;
associating the graphic box with information related to the product; and
displaying the graphic box that encloses the product in the TV program, and displaying the information associated with the graphic box in the TV program, in response to detecting a selection operation of selecting the product.

11. The device of claim 10, wherein the operations further comprise:
defining one or more keywords for the product;
searching more information related to the product by loading one or more keywords of the product in a search engine, in response to detecting the selection operation of selecting the product; and
displaying the searched information on the display device.

12. The device of claim 10, wherein the operations further comprise:
when the selection operation is detected as being deactivated, not displaying the graphic box and the information associated with the graphic box.

13. The device of claim 10, wherein the information associated with the graphic box is displayed in the graphic box or outside the graphic box.

14. The device of claim 10, wherein the information associated with the graphic box comprises image information and character information.

15. The device of claim 11, wherein the operations further comprise:
recording the one or more keywords of the product in an image file that is compatible with the TV program.

16. The device of claim 11, wherein the image file is embedded in a TV signal or a video file of the TV program.

17. A non-transitory computer-readable medium having stored thereon instructions that, when executed by at least one processor of an electronic device, cause the at least one processor to perform a method comprising:
enclosing a product presented in a TV program in a graphic box, and hiding the graphic box in the TV program;
associating the graphic box with information related to the product; and
displaying the graphic box that encloses the product in the TV program, and displaying the information associated with the graphic box in the TV program, in response to detecting a selection operation of selecting the product.

18. The non-transitory computer-readable medium of claim 17, wherein the method further comprises:
defining one or more keywords for the product;
searching more information related to the product by loading one or more keywords of the product in a search engine, in response to detecting the selection operation of selecting the product; and
displaying the searched information on the display device.

19. The non-transitory computer-readable medium of claim 17, wherein the method further comprises:
when the selection operation is detected as being deactivated, not displaying the graphic box and the information associated with the graphic box.
